(19) United States
(12) Patent Application Publication
(10) Pub. No.: US 2016/0040054 A1
(43) Pub. Date: Feb. 11, 2016

(54) METHODS FOR ORGANIC NUCLEATING AGENTS

(71) Applicant: ENTROPY SOLUTIONS INC., Plymouth, MN (US)

(72) Inventors: Monte Christopher MAGILL, Plymouth, MN (US); Michael Hugh EDGAR, Tuscaloosa, AL (US); William Rusty SUTTERLIN, Tuscaloosa, AL (US)

(21) Appl. No.: 14/776,486

(22) PCT Filed: Mar. 13, 2014
(86) PCT No.: PCT/US2014/026712

§ 371 Date: Sep. 14, 2015

Related U.S. Application Data
(60) Provisional application No. 61/799,025, filed on Mar. 15, 2013.

(51) Int. Cl. C09K 5/06

(52) U.S. Cl. CPC C09K 5/063

(57) ABSTRACT

The invention provides phase change material comprising organic phase change materials comprising a miscible organic nucleating material, seed crystal or organic nucleating agent to minimize supercooling during the crystallization of the phase change material. The miscible organic material acting as an organic nucleating material, seed crystal or organic nucleating agent, is in sufficiently small enough ratios so as not to interfere with the latent heat properties of the phase change material, but amounts sufficient to inhibit the appearance of supercooling. The organic nucleating material, seed crystal or organic nucleating agent comprises a polyolefin or polyalkene, or a polyethylene or a polypropylene, or a nanoparticle or a microcapsule thereof. The invention provides an article of manufacture, a coating, a latent heat storage unit, a liquid, a gel, an antifreeze fluid, a fluid, an ink, an oil, a lubricant, a sealant, a paint, a textile, a cloth, or a bedding.

### RELATED APPLICATIONS

This application claims the benefit of priority to U.S. Provisional Patent Application Ser. No. 61/799,025, filed Mar. 15, 2013. The aforementioned application is expressly incorporated herein by reference in its entirety and for all purposes.

### TECHNICAL FIELD

This invention generally relates to thermoregulation, thermal protection and insulation, and nucleating agents. In particular, in alternative embodiments, the invention provides phase change material-comprising compositions, or organic phase change materials comprising a miscible organic material that acts as an organic nucleating material, seed crystal or organic nucleating agent to minimize supercooling during the crystallization of the phase change material. In alternative embodiments, the miscible organic material acting as an organic nucleating material, seed crystal or organic nucleating agent, is in sufficiently small enough ratios so as not to interfere with the latent heat properties of the phase change material, but amounts sufficient to inhibit the appearance of supercooling. In alternative embodiments, the organic nucleating material, seed crystal or organic nucleating agent comprises a polyolefin or polyalkene, or a polyethylene or a polypropylene, or a nanoparticle or a microcapsule thereof. In alternative embodiments, the invention provides an article of manufacture, a product of manufacture, a coating, a latent heat storage (LHS) unit, a liquid, a gel, an antifreeze fluid, a fluid, an ink, an oil, a lubricant, a sealant, a paint, a textile, a cloth, a clothing, a bedding or bedding system comprising a phase change material-comprising composition of the invention.

### BACKGROUND

Phase change materials are chemical entities which have the ability to absorb, store and release large amounts of thermal energy while they go through a change in phase, for example, from solid to liquid, liquid to gas, gas to liquid and liquid to solid. This phase change is commonly associated with a specific temperature or temperature range. Chemically, phase change materials can be salts, salt hydrates, petroleum derived alkanes, fatty acids, fatty acid esters, etc. Water is actually a phase change material and, when used as ice, one of the most ubiquitous of all phase change materials.

An issue commonly associated with phase change materials is “supercooling”. This phenomenon is where the crystallization point becomes unusually lower than what its associated melting point. A normal crystallization point may be from 1 to 5 degrees Celsius lower than its melting point. When supercooling occurs the crystallization point will be greater than 5 degrees Celsius lower than its melting point and sometimes as much as 15 degrees Celsius lower. This occurs when no seed crystal forms to initiate the crystallization, or solidification, process. The probability of this seed crystal initiation diminishes as the volume of the container it is held in decreases or as the container itself has smoother and smoother walls.

This supercooling problem is very commonly found when microencapsulating phase change materials, and can be even more pronounced as the particle size gets smaller and smaller, especially below 15 microns in size. When supercooling occurs in a phase change material it tends to render it less functional or unpredictable, at the very least.

A common practice in the plastics industry, and with phase change materials, is to add a nucleating agent to act as an artificial seed crystal. Normally these materials are inorganic or non-miscible in nature. Such nucleating materials can be talcs, diatomaceous earth, silicas, silicates and the like. Two issues associated with these non-miscible materials is keeping them in suspension and, in the case of microencapsulation, particle size. The falling out of suspension makes the crystallization more localized and unpredictable or, in the case of processing materials with such inorganic, non-miscible nucleating agents, can create highly variable levels of nucleating agent concentrations. These concentrations may vary from as little as none, and back to the original supercooling problem, or be so highly concentrated that the original desired plastic strengths or phase change material latent heats are compromised to the point of being non-useable.

When such non-miscible nucleating agents used with phase change materials are being microencapsulated, they present a couple of additional issues. They have a tendency to separate during the emulsification process and create a scenario where some microcapsules may have little to no nucleating agent and others an overabundance. This not only allows the supercooling to continue in some microcapsules but it also can create a huge range of densities of them which leads to other processing issues downstream. If the particle size of the nucleating agent exceeds the size of the smaller microcapsules in the batch, then those smaller microcapsules will obviously have no nucleating agent present, and a higher concentration in the larger microcapsules, but still with some of the microencapsulated phase change materials exhibiting the supercooling phenomenon.

The other issue created is the possible interference that these non-miscible materials with the microcapsule wall formation. If they become partially or fully embedded in the microcapsule wall materials they compromise the integrity and performance of the microcapsules themselves. And since the goal of any microencapsulated phase change material is to never release its contents, this weakened shell strength is hugely problematic.

All the various types of phase change materials, whether they be salts, salt hydrates, alkanes, fatty acids or fatty acid esters, exhibit the problem of supercooling to one degree or another and under various conditions. There have been various methods or additives to reduce the appearance of this supercooling phenomenon, but these solutions may in turn present other issues as mentioned above.

### SUMMARY

In alternative embodiments, the invention provides phase change material-comprising compositions, comprising:

(a) an organic phase change material, and

(b) an organic material that acts as a nucleating agent (an organic nucleating material), a seed crystal, or an organic nucleating agent,

wherein the organic nucleating material, seed crystal or organic nucleating agent is at least partly, or is substantially, miscible in the organic phase change material, wherein optionally substantially miscible is about 99%, 98%, 97%, 96% or 95% miscible in the organic phase change material,

and the organic nucleating material, seed crystal or organic nucleating agent has a longer chain or a higher melt point than its corresponding organic phase change material, but is not too close in weight or concentration as to form a different latent heat and melt point from the original phase change material (the organic phase change material before addition of the organic nucleating material, seed crystal or organic nucleating agent,

and the organic material that acts as an organic nucleating material, seed crystal or organic nucleating agent, acts to minimize supercooling during the crystallization of the organic phase change material, wherein the miscible organic nucleating material, seed crystal or organic nucleating agent is in sufficiently small enough ratios so as not to interfere with the latent heat properties of the organic phase change material, but enough to inhibit the appearance of supercooling.

In alternative embodiments, the organic phase change material comprises:

an alkane or a paraffin; an olefin or an alkene; a cyclic or acyclic or aliphatic olefin; an acyclic dialkene or acyclic diene; a petroleum derived alkane, olefin or an alkene; a fatty acid; a fatty acid ester; or, a combination thereof,

or a lauryl laurate, an octyl palmitate, a methyl palmitate, a methyl stearate, a methyl myristate, a methyl lauryl, a lauryl alcohol, a decanol, a stearyl stearate, a lauryl stearate, or a combination thereof,

wherein optionally the fatty acid is or comprises: a short-chain fatty acid (SCFA), or a fatty acids with an aliphatic tail of fewer than six carbons, or a butyric acid; or a medium-chain fatty acids (MCFA), or a fatty acid with an aliphatic tails of about 6 to 12 carbons; a long-chain fatty acid (LCFA), or a fatty acid with an aliphatic tail of between 13 to 21 carbons, or between about 10 to 24 carbons; or, a very long chain fatty acid (VLCFA), or a fatty acids with an aliphatic tails longer than 22 carbons, or between about 22 and 30 carbons; or any combination thereof,

and optionally the fatty acid is a saturated or an unsaturated fatty acid,

and optionally the fatty acid is: a myristoleic acid or 9-tetradecenoic acid; a palmitoleic acid or 9-hexadecenoic acid; a sapienic acid, an oleic acid; an elaidic acid; a vaccenic acid; a linoleic acid; a linoelaidic acid; an arachidonic acid, or any combination thereof.

In alternative embodiments, the organic nucleating material, seed crystal or organic nucleating agent is fully or completely miscible in the organic phase change material.

In alternative embodiments, the organic nucleating material, seed crystal or organic nucleating agent is a particle or a nanoparticle, or a capsule or a microcapsule, having a size of between about 5 nanometers (nm) to about 500 nm, or between about 10 to 400 nm, or between about 1 to 100 nm, or between about 20 to 300 nm.

In alternative embodiments, the organic nucleating material, seed crystal or organic nucleating agent comprises a polyolefin or polyalkene, wherein optionally the polyolefin comprises a poly-alpha-olefin, and optionally in a quantity of between about 0.01% to 1% by mass, or between about 0.1% to 0.5% by mass, or between about 0.01% to 0.1% by mass, or between about 0.5% to 1% by mass.

In alternative embodiments, the organic nucleating material, seed crystal or organic nucleating agent comprises a polyethylene (or polyethene or poly(methylene)) or a polypropylene (or polypropene), or a nanoparticle or a microcapsule comprising a polyethylene or a polypropylene. In alternative embodiments, the polyethylene comprises an ultra-high-molecular-weight polyethylene (UHMWPE), a high-density polyethylene (HDPE), a cross-linked polyethylene (PEX or XLPE), a medium-density polyethylene (MDPE), a linear low-density polyethylene (LLDPE), a low-density polyethylene (LDPE), a very-low-density polyethylene (VLDPE), a chlorinated polyethylene, or a combination thereof. In alternative embodiments, the polypropylene comprises a polypropylene carbonate (PPC), a Polypropylene glycol or a polypropylene oxide.

In alternative embodiments, the organic nucleating material, seed crystal or organic nucleating agent comprises an alkane, a fatty acid or a fatty acid ester, and the organic nucleating material or the organic nucleating agent is only between about 0.5% to 20% of the total amount of the organic phase change material or phase change material-comprising composition.

In alternative embodiments, the organic nucleating material, seed crystal or organic nucleating agent is between about 1% and 15%, or about 0.5% to 20%, or about 0.1% to 10%, of the total amount of the organic phase change material or phase change material-comprising composition. In alternative embodiments, the organic nucleating material, seed crystal or organic nucleating agent is about 0.1%, 0.5%, 1%, 2%, 3%, 4%, 5%, 6%, 7%, 8%, 9%, 10%, 11%, 12%, 13%, 14% or 15% or more of the total amount of the organic phase change material or phase change material-comprising composition.

In alternative embodiments, the alkane organic nucleating material, seed crystal or organic nucleating agent is between about 3 to 30 carbons in length, or the alkane organic nucleating material, seed crystal or organic nucleating agent is between about 4 to 20 carbons in length, or the alkane organic nucleating material, seed crystal or organic nucleating agent is between about 5 to 15 carbons in length, or the alkane organic nucleating material, seed crystal or organic nucleating agent is 3, 4, 5, 6, 7, 8, 9, 10, 11, 12, 13, 14, 15, 16, 17, 18, 19 or 20 carbons in length, or the alkane organic nucleating material, seed crystal or organic nucleating agent is a branched alkane, which optionally is a 2-methylbutane, a 2,2-dimethylpropane, a 2-methylpentane, a 3-ethylpentane, a 3,3-dimethylhexane, a 2,3-dimethylhexane, a 4-ethyl-2-methylhexane, or equivalents, or the alkane organic nucleating material, seed crystal or organic nucleating agent is a cycloalkane, or a cyclobutane.

The invention provides methods for making the phase change material-comprising composition of the invention, comprising blending or mixing the organic phase change material and the organic nucleating material, seed crystal or organic nucleating agent after heating to above the melting point of both components either prior to or after they are mixed together.

The invention provides a particle, a capsule, a nanoparticle or a microcapsule comprising a phase change material-comprising composition of the invention.

The invention provides an article of manufacture, a product of manufacture, a latent heat storage (LHS) unit, a coating, a liquid, a gel, an antifreeze fluid, a fluid, an ink, an oil, a lubricant, a sealant, a paint, a textile, a cloth, a clothing, a bedding or bedding system, comprising: a particle, a capsule, a nanoparticle or a microcapsule of the invention, or a comprising a phase change material-comprising composition of the invention.

The details of one or more embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference for all purposes.

### BRIEF DESCRIPTION OF THE DRAWINGS

The drawings set forth herein are illustrative of embodiments of the invention and are not meant to limit the scope of the invention as encompassed by the claims.

Figures are described and discussed herein.

FIG. 1 graphically illustrates the heat flow versus temperature properties of an organic phase change material (PCM) without a nucleating agent.

FIG. 2 graphically illustrates the heat flow versus temperature properties of an exemplary composition of the invention comprising an organic phase change material (PCM) and an organic nucleating agent.

FIG. 3 graphically illustrates the heat flow versus temperature properties of a phase change material (PCM) that is not microencapsulated.

FIG. 4 graphically illustrates the heat flow versus temperature properties of a phase change material (PCM) that is microencapsulated, having no nucleation seed crystal.

FIG. 5 graphically illustrates the heat flow versus temperature properties of a phase change material (PCM) that is microencapsulated, having a nucleation seed crystal.

FIG. 6 graphically illustrates the heat flow versus temperature properties of a phase change material (PCM) that is microencapsulated, having a nucleation seed crystal.

FIG. 7 graphically illustrates the heat flow versus temperature properties of a phase change material (PCM) that is microencapsulated, having a nucleation seed crystal.

Like reference symbols in the various drawings indicate like elements.

Reference will now be made in detail to various exemplary embodiments of the invention, examples of which are illustrated in the accompanying drawings. The following detailed description is provided to give the reader a better understanding of certain details of aspects and embodiments of the invention, and should not be interpreted as a limitation on the scope of the invention.

### DETAILED DESCRIPTION

In alternative embodiments, the invention provides organic phase change materials or a phase change material-comprising compositions, comprising: an organic phase change material; and, a miscible organic material that acts as a nucleating agent to minimize supercooling during the crystallization of the phase change material, wherein the miscible organic material is in sufficiently small enough ratios so as not to interfere with the latent heat properties of the phase change material but enough to inhibit the appearance of supercooling.

In alternative embodiments, compositions of the invention avoid or ameliorate problems associated with using inorganic nucleating agents in phase change materials by using organic nucleating agents. Furthermore, these organic nucleating agents are fully miscible in the associated phase change material so as to avoid any separation issues or density variability issues. In alternative embodiments, organic phase change materials used to practice this invention may be alkanes, petroleum derived or otherwise, fatty acids or fatty acid esters.

The organic nucleating agents are likewise alkanes, fatty acids or fatty acid esters (corresponding to the organic phase change material it will be used with). In alternative embodiments, a small ratio of organic nucleating agents to organic phase change material is used in a phase change material-comprising composition of the invention. For example, this is usually going to be less than about 15%, or alternatively, less than about 5%, or at about 0.5%, 1%, 2%, 3%, 4%, 5%, 6%, 7%, 8%, 9%, 10%, 11%, 12%, 13%, 14% or 15% of the total amount of the organic phase change material or phase change material-comprising composition, depending on the combinations used.

In alternative embodiments, the organic nucleating agent is of similar structure or chemistry to the organic phase change material; but most important, they are always miscible with each other. In alternative embodiments, the organic nucleating agent is a longer chain or higher melt point than its corresponding organic phase change material, but not too close in weight or concentration as to form a eutectic of a different latent heat and melt point from the original phase change material (a eutectic system is a mixture of chemical compounds or elements that has a single chemical composition that solidifies at a lower temperature than any other composition made up of the same ingredients; this composition is known as the eutectic composition and the temperature at which it solidifies is known as the eutectic temperature). The blending of the organic phase change material and the corresponding organic nucleating agent is accomplished by heating to above the melting point of both components either prior to or after they are mixed together. The organic nucleating agent and/or the organic phase change material may be partially heated (below the melting point of both components) before adding, and then the heating to above the melting point of both components is accomplished after the blending, mixing or adding step. Once successfully blended then a favorable thermally induced phase separation upon cooling will create the desired seed crystals for nucleating the crystallization of the phase change material with little to no supercooling present.

The following examples, and the figures, are intended to clarify the invention, and to demonstrate and further illustrate certain preferred embodiments and aspects without restricting the subject of the invention to the examples and figures.

### Examples

### Example 1

### Organic Phase Change-Comprising Compositions of the Invention Minimize Supercooling During the Crystallization of the Phase Change Material

The following example describes exemplary organic phase change-comprising compositions of the invention that minimize supercooling during the crystallization of the phase change material. Exemplary phase change materials used in this study included: lauryl laurate, octyl palmitate, methyl palmitate, methyl stearate, methyl myristate, methyl lauryl, lauryl alcohol and decanol. Organic nucleating agent examples included stearyl stearate and lauryl stearate.

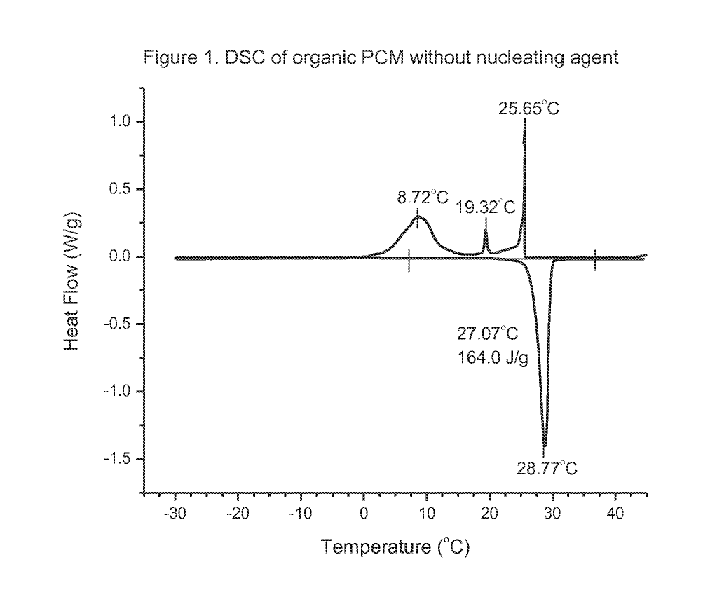

FIG. 1 graphically illustrates the heat flow versus temperature properties of an organic phase change material (PCM) without a nucleating agent.

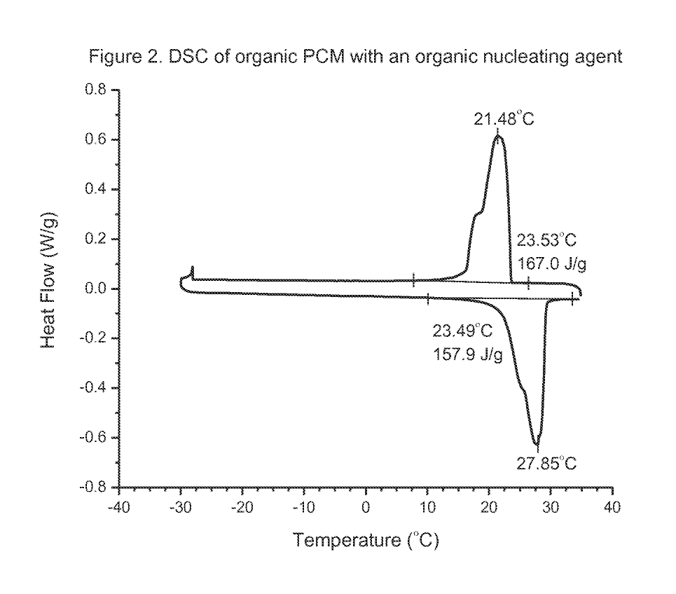

FIG. 2 graphically illustrates the heat flow versus temperature properties of an exemplary composition of the invention comprising an organic phase change material (PCM) and an organic nucleating agent.

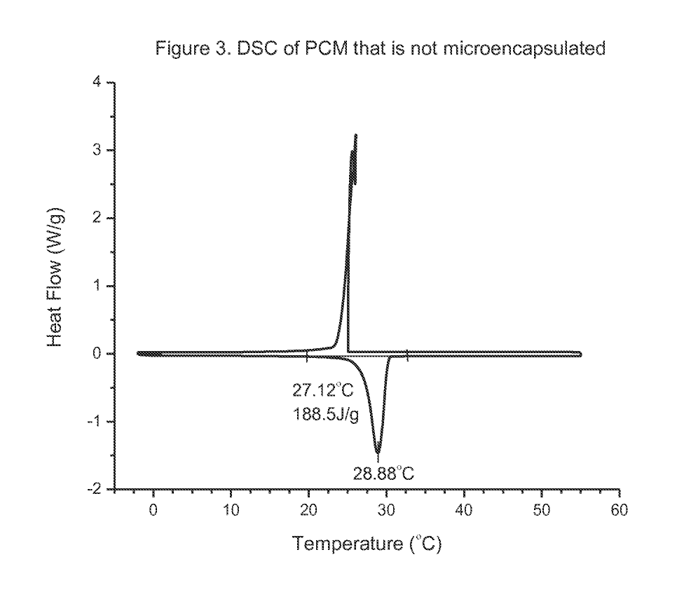

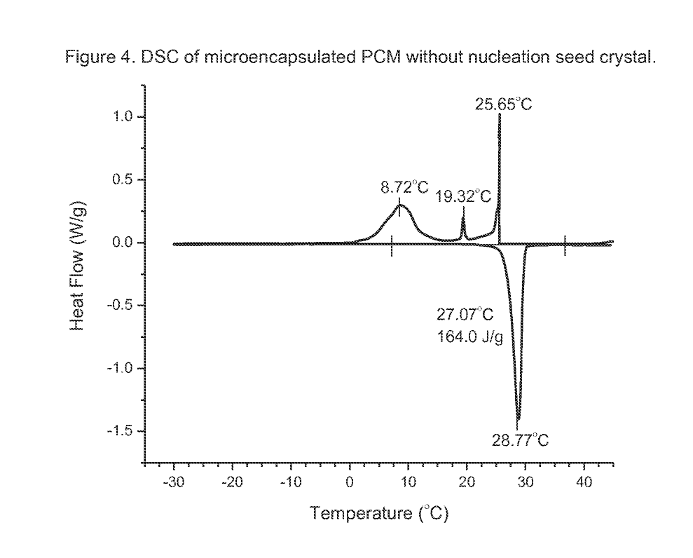

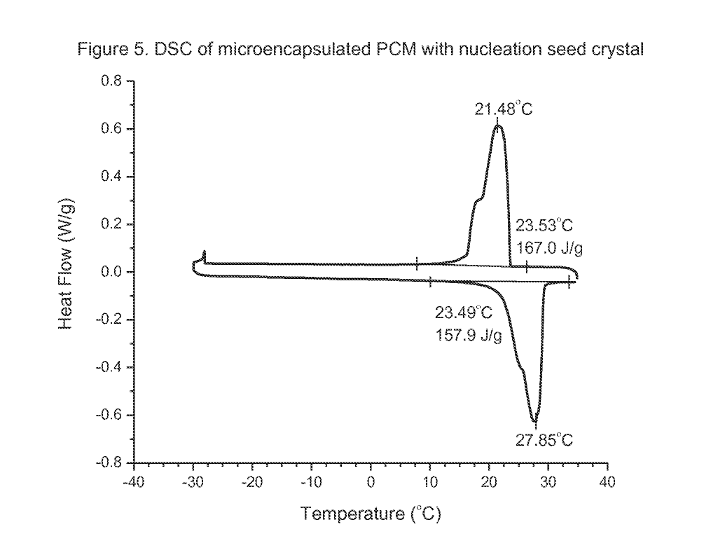

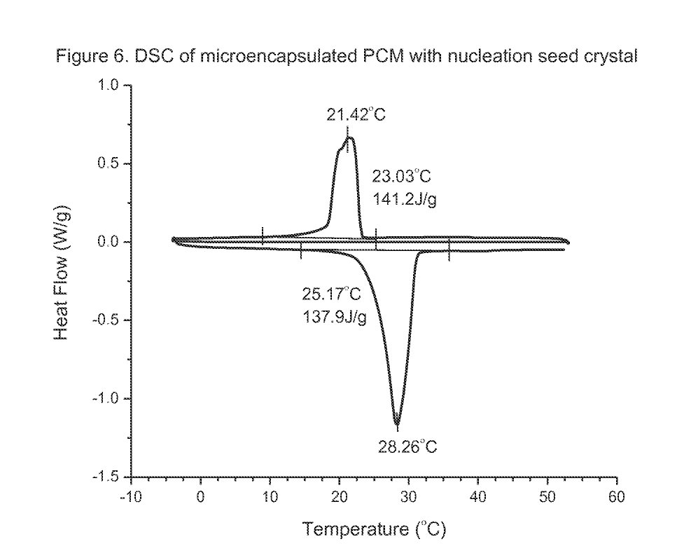

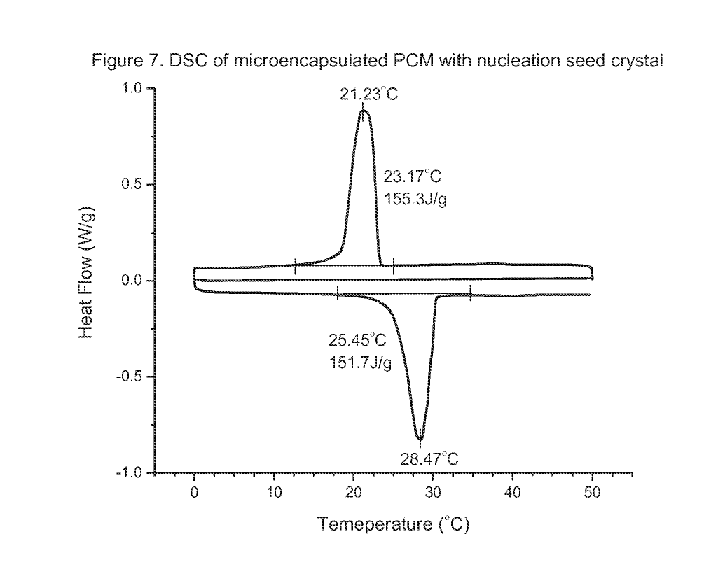

FIGS. 1 to 7 were generated on a differential scanning calorimeter (DSC) at a scan rate of 1 C/min. The first figures (FIGS. 1 to 4) show a DSC of a PCM with a melting point of around 28° C. and a freezing point of around 25° C. After the PCM is microencapsulated the melting point of around 28° C. is not affected, but the freeze point is now depressed with the solidification of the majority of the PCM not occurring until the temperature is below 8° C. This is due to supercooling. However, if the PCM is seeded in the microsphere as seen in the last 3 figures (FIGS. 5 to 7) then the supercooling effect is diminished. FIG. 5 contains a fatty acid ester as the seeding agent. FIG. 6 contains nano polyethylene as the seeding agent. FIG. 7 contains nano polypropylene as the seeding agent.

In alternative embodiments, the invention provides various hard sided and soft sided packs of PCMs. As a motivation to development the invention, it was noticed that in placing PCM packs in a refrigerator or freezer at a temperature at which they should normally crystallize that some of the packs did not solidify, even with extensive amount of time. When using inorganic, non-miscible nucleating agents there would be a separation in the packs compromising its effectiveness as a nucleating agent. Using miscible organic nucleating agents of this invention in the PCM resulted in the PCM-nucleating agent compositions of this invention, which work effectively (as PCM-nucleating agents) regardless of how long the compositions of this invention may be used or how many thermocycles they would go through.

In alternative embodiments, another application of this invention comprises the use of microencapsulated phase change materials. Because microcapsules are typically very small in size, generally 10 microns or less, the problem is heightened since the probably of seed crystal initiation, without a nucleating agent present, becomes greatly decreased because of the extremely small volume of phase change material contained in each microcapsule. The addition of various inorganic nucleating agents resulted in an uneven distribution of it in the microcapsules and some of the microcapsules, especially the smaller ones having none in them. The use of compositions of this invention that comprise PCM and an organic nucleating agent insures that the distribution ratio of nucleating agent in each microcapsule remains the same, regardless of the particle size. In alternative embodiments, applications of exemplary microencapsulated phase change materials include use in clothing or bedding systems. In alternative embodiments, use of compositions of the invention prevent unwanted or damaging supercooling; if there is any supercooling present then the effectiveness of the phase change materials in managing temperature is either greatly diminished or entirely removed. In alternative embodiments compositions of the invention are every effective for such applications—preventing unwanted or damaging supercooling.

A number of embodiments of the invention have been described. Nevertheless, it will be understood that various modifications may be made without departing from the spirit and scope of the invention. Accordingly, other embodiments are within the scope of the following claims.

1. A phase change material-comprising composition, comprising:
(a) an organic phase change material, and
(b) an organic material that acts as a nucleating agent or a nucleating material, a seed crystal, or an organic nucleating agent or organic nucleating material,
wherein the organic nucleating material, seed crystal or organic nucleating agent is at least partly, or is substantially, miscible in the organic phase change material,
and the organic nucleating material, seed crystal or organic nucleating agent has a longer chain or a higher melt point than its corresponding organic phase change material, but is not too close in weight or concentration as to form a different latent heat and melt point from the original organic phase change material before addition of the organic nucleating material, seed crystal or organic nucleating agent,
and the organic material that acts as an organic nucleating material, seed crystal or organic nucleating agent, acts to minimize supercooling during the crystallization of the organic phase change material, wherein the miscible organic nucleating material, seed crystal or organic nucleating agent is in sufficiently small enough ratios so as not to interfere with the latent heat properties of the organic phase change material, but enough to inhibit the appearance of supercooling.

2. The phase change material-comprising composition of claim 1, wherein the organic phase change material comprises:
an alkane or a paraffin; an olefin or an alkene; a cyclic or acyclic or aliphatic olefin; an acyclic dialkene or acyclic diene; a petroleum derived alkane, olefin or an alkene; a fatty acid; a fatty acid ester; or, a combination thereof,
or a lauryl laurate, an octyl palmitate, a methyl palmitate, a methyl stearate, a methyl myristate, a methyl lauryl, a lauryl alcohol, a decanol, a stearyl stearate, a lauryl stearate, or a combination thereof.

3. The phase change material-comprising composition of claim 1, wherein the organic nucleating material, seed crystal or organic nucleating agent is fully or completely miscible in the organic phase change material.

4. The phase change material-comprising composition of claim 1, wherein the organic nucleating material, seed crystal or organic nucleating agent is a particle or a nanoparticle, or a capsule or a microcapsule, having a size of between about 5 nanometers (nm) to about 500 nm.

5. The phase change material-comprising composition of claim 1, wherein the organic nucleating material, seed crystal or organic nucleating agent comprises a polyolefin or polyalkene,
wherein optionally the polyolefin comprises a poly-alpha-olefin,
and optionally in a quantity of between about 0.01% to 1% by mass, or between about 0.1% to 0.5% by mass, or between about 0.01% to 0.1% by mass, or between about 0.5% to 1% by mass.

6. The phase change material-comprising composition of claim 1, wherein the organic nucleating material, seed crystal or organic nucleating agent comprises a polyethylene (or polyethene or poly(methylene)) or a polypropylene (or polypropene), or a nanoparticle or a microcapsule comprising a polyethylene or a polypropylene.

7. The phase change material-comprising composition of claim 6, wherein the polyethylene comprises an ultra-high-molecular-weight polyethylene (UHMWPE), a high-density polyethylene (HDPE), a cross-linked polyethylene (PEX or XLPE), a medium-density polyethylene (MDPE), a linear low-density polyethylene (LLDPE), a low-density polyethylene (LDPE), a very-low-density polyethylene (VLDPE), a chlorinated polyethylene, or a combination thereof.

8. The phase change material-comprising composition of claim 6, wherein the polypropylene comprises a polypropylene carbonate (PPC), a Polypropylene glycol or a polypropylene oxide.

9. The phase change material-comprising composition of claim 1, wherein the organic nucleating material, seed crystal or organic nucleating agent comprises an alkane, a fatty acid or a fatty acid ester, and the organic nucleating material or the organic nucleating agent is only between about 0.5% to 20% of the total amount of the organic phase change material or phase change material-comprising composition.

10. The phase change material-comprising composition of claim 1, wherein about the organic nucleating material, seed crystal or organic nucleating agent is between about 1% and 15%, or about 0.5% to 20%, or about 0.1% to 10%, of the total amount of the organic phase change material or phase change material-comprising composition.

11. The phase change material-comprising composition of claim 1, wherein about the organic nucleating material, seed crystal or organic nucleating agent is about 0.1%, 0.5%, 1%, 2%, 3%, 4%, 5%, 6%, 7%, 8%, 9%, 10%, 11%, 12%, 13%, 14% or 15% or more of the total amount of the organic phase change material or phase change material-comprising composition.

12. The phase change material-comprising composition of claim 9, wherein the alkane organic nucleating material, seed crystal or organic nucleating agent is between about 3 to 30 carbons in length, or the alkane organic nucleating material, seed crystal or organic nucleating agent is between about 4 to 20 carbons in length, or the alkane organic nucleating material, seed crystal or organic nucleating agent is between about 5 to 15 carbons in length, or the alkane organic nucleating material, seed crystal or organic nucleating agent is 3, 4, 5, 6, 7, 8, 9, 10, 11, 12, 13, 14, 15, 16, 17, 18, 19 or 20 carbons in length.

13. A method for making the phase change material-comprising composition of claim 1, comprising blending or mixing the organic phase change material and the organic nucleating material, seed crystal or organic nucleating agent after heating to above the melting point of both components either prior to or after they are mixed together.

14. A particle, a capsule, a nanoparticle or a microcapsule comprising a phase change material-comprising composition of claim 1.

15. An article of manufacture, a product of manufacture, a latent heat storage (LHS) unit, a coating, a liquid, a gel, an antifreeze fluid, a fluid, an ink, an oil, a lubricant, a sealant, a paint, a textile, a cloth, a clothing, a bedding or bedding system, comprising: a particle, a capsule, a nanoparticle or a microcapsule of claim 14.

16. An article of manufacture, a product of manufacture, a latent heat storage (LHS) unit, a coating, a liquid, a gel, an antifreeze fluid, a fluid, an ink, an oil, a lubricant, a sealant, a paint, a textile, a cloth, a clothing, a bedding or bedding system, comprising: a phase change material-comprising composition of claim 1.

17. The phase change material-comprising composition of claim 2, wherein:
(a) the fatty acid is or comprises: a short-chain fatty acid (SCFA), or a fatty acids with an aliphatic tail of fewer than six carbons, or a butyric acid; or a medium-chain fatty acids (MCFA), or a fatty acid with an aliphatic tails of about 6 to 12 carbons; a long-chain fatty acid (LCFA), or a fatty acid with an aliphatic tail of between 13 to 21 carbons, or between about 10 to 24 carbons; or, a very long chain fatty acid (VLCFA), or a fatty acids with an aliphatic tails longer than 22 carbons, or between about 22 and 30 carbons; or any combination thereof,
(b) the fatty acid is a saturated or an unsaturated fatty acid, or
(c) the fatty acid is: a myristoleic acid or 9-tetradecenoic acid; a palmitoleic acid or 9-hexadecenoic acid; a sapienic acid, an oleic acid; an elaidic acid; a vaccenic acid; a linoleic acid; a linoelaidic acid; an arachidonic acid, or any combination thereof.

18. The phase change material-comprising composition of claim 2,
wherein the organic nucleating material, seed crystal or organic nucleating agent is substantially, miscible in the organic phase change material, and substantially miscible is about 99%, 98%, 97%, 96% or 95% miscible in the organic phase change material.

19. The phase change material-comprising composition of claim 4,
wherein the organic nucleating material, seed crystal or organic nucleating agent is a particle or a nanoparticle, or a capsule or a microcapsule, has a size of between about 10 to 400 nm, or between about 1 to 100 nm, or between about 20 to 300 nm.

20. The phase change material-comprising composition of claim 12, wherein material, seed crystal or organic nucleating agent is a branched alkane, or a 2-methylbutane, a 2,2-dimethylpropane, a 2-methylpentane, a 3-ethylpentane, a 3,3-dimethylhexane, a 2,3-dimethylhexane, a 4-ethyl-2-methylhexane, or equivalents, or the alkane organic nucleating material, seed crystal or organic nucleating agent is a cycloalkane, or a cyclobutane.
